(19) United States
(12) Patent Application Publication
(10) Pub. No.: US 2012/0107782 A1
(43) Pub. Date: May 3, 2012

(54) Training device for martial artists and boxers

(76) Inventor: Andrew Silva, Beverly, MA (US)

(21) Appl. No.: 12/925,811

(22) Filed: Nov. 1, 2010

(51) Int. Cl. G09B 19/00

(52) U.S. Cl. 434/258

(57) ABSTRACT

A trainer for a martial artist or boxer is provided comprising a container, a movable element positioned within container and a handle for grasping the trainer. The movable element produces an audible signal when it strikes a forward surface of the container and a muted audible signal or no audible signal when it strikes a rearward surface of the container.

### BACKGROUND OF THE INVENTION

This invention relates to an apparatus for training martial artists and boxers. More particularly, this invention relates to such a training apparatus for delivering a blow from the hands of a user.

In sports, where a hand blow is delivered to an opponent during competition, the proficiency of the blow is measured by coordination of hand movement, precision of hand movement, power of the blow delivery and endurance during the competition.

Coordination is the quality which enables the individual to integrate all the powers and capacities of his body into effectively coordinating an act. Before movements take place, there must be a change of muscular tension on both sides of the joints to be moved. The effectiveness of this muscular teamwork is one of the factors which determine limits of speed, endurance, power, agility and accuracy in an athletic movement. When rapid muscle motion takes place, the muscles closing the joints shorten and those on the opposite side lengthen to permit the movement. There is still tension on both sides of the joint, but on the lengthening side, it is considerable reduced. Any excessive tension in the lengthening muscles acts as a brake and thereby slows and weakens the action. Such antagonistic tension increases the energy cost of muscular work, resulting in early fatigue. When a new task with a demand that is different in intensity of load, rate, repetition or duration is undertaken, an entirely new pattern of “neurophysiological adjustment” must be acquired. Thus, the fatigue experienced in new activities is not just from using different muscles but is also due to the braking caused by improper coordination. The boxer or marital artist who never seems to find the proper distance, is always being timed, never “out-guesses” his opponent, and always gives warning of his intentions before they become serious, is suffering chiefly from a lack of coordination. In contrast, the well-coordinated fighter exhibits smooth and graceful movement.

Muscles have no power to guide themselves, but the manner in which they act, and consequently the effectiveness of our performances, depends on how the nervous system guides them. Thus, a badly executed move is the result of impulses sent to the wrong muscles by the nervous system, or sent a fraction of a second too soon or too late, or sent in improper sequences or in poorly apportioned intensity. Well-executed movement means the nervous system has been trained to the point where it sends impulses to certain muscles, causing these muscles to contract at exactly the proper fraction of a second. At the same time, impulses to the antagonistic muscles are shut off, allowing those muscles to relax. Properly coordinated impulses surge with the intensity required and they stop at the fraction of a second when they are no longer needed. Therefore, learning coordination is a matter of training the nervous system and not a question of training muscles. The transition from totally uncoordinated muscular effort to skill of the highest perfection is a process of developing the connections in the nervous system.

Training for skill (coordination) is a matter of forming proper connections in the nervous system through practice (precision practice). Each performance of an act strengthens the connections involved and makes the next performance easier, more certain, and more readily done.

Precision of movement means accuracy and generally is used in the sense of exactness in the projection of a force. Precision is made up of controlled body movements. These movements should eventually be executed with a minimum amount of strength and exertion, while still achieving the desired result. Precision can only be attained through a considerable amount of practice and training. Skill is best acquired by learning accuracy and precision first with speed before the skill act is attempted with much power and speed.

To be accurate, the striking or throwing skills should be executed from a body base that possesses enough strength to maintain adequate balance during the action. To appropriate incorporate momentum with mechanical advantage, neural impulses are sent to the working muscle to bring a sufficient number of fibers into action at precisely the right time, while impulses to the antagonistic muscles are reduced to lessen the resistance, all acting to improve efficiency and to make the best use of available power.

Endurance is developed by hard and continuous exercise which exceeds the “steady” physiological state and produces near exhaustion, temporarily.

Exercises which increase skill and flexibility of both hands are an indispensable building block for the martial artist or boxer. Shadow boxing is a good agility exercise as well as a method for building up speed. Shadow boxing helps wind, speed, gives ideas and helps the mind fix boxing moves ready for use when they are most wanted.

Accordingly, it would be desirable to provide a training device for martial artists and boxers which provides improvement for coordination, precision of hand movements, power improvement and endurance when training for future competition.

### SUMMARY OF THE INVENTION

The martial artist or boxer (user) trainer of this invention includes a container having two closed ends, a movable element such as a ball or disc positioned within the container and a handle attached to the container that is grasped in the fingers of the user. The trainer optionally can include a strap for securing the container to the hand of the user. The movable element moves within the container in response to movement of the user's hand. The user's hand is caused to move by a combination of the user's arm movement and wrist movement. When the movable element is moved forward by the user's hand movement, it strikes the inner surface of the forward end of the container to produce an audible noise. When the movable element is moved backward within the container by the user cocking his wrist, the movable element strikes the inner surface of the rearward end of the container. This inner surface at the rearward end is formed of an energy absorbing material so that little or no sound is produced when the movable element strikes it. Thus, the trainer provides a different sound when the movable element is in the forward position which is in contrast with the sound or no sound emitted when the movable element is in the rearward position.

The movable element is positioned at the rearward end of the container when the user's wrist is cocked. The movable element is moved to the forward end of the container when the user's cocked wrist is released. The user, upon hearing that the movable element has struck the forward inner surface of the container is provided with an audible noise that informs him both of the timing and degree of force that the movable element strikes the inner surface at the forward end of the container. The user then can correlate the force and timing of the hand delivered blow with the user's knowledge of the timing and extent of muscle movement he has exerted. By repeating the arm and hand movement, the user is provided with the knowledge required to deliver a well time and high strength hand blow to a competitor. Repeated training with the training device of this invention provides improved proficiency for delivering an effective hand blow to a competitor.

### BRIEF DESCRIPTION OF THE DRAWINGS

FIG. 1 is a side view of this invention utilizing a ball as the movable element.

FIG. 2 is a cross sectional view of the trainer of FIG. 1 taken along line 2-2.

FIG. 3 is a bottom view of this invention utilizing a disc as the model element.

FIG. 4 is a cross sectional side view of the trainer of FIG. 3.

FIG. 5 is a cross sectional view of the trainer of FIG. 4 taken along line 5-5.

FIG. 6 illustrates the use of this invention when the user's wrist is cocked.

FIG. 7 illustrates the use of this invention when the user's wrist is released.

### DESCRIPTION OF SPECIFIC EMBODIMENTS

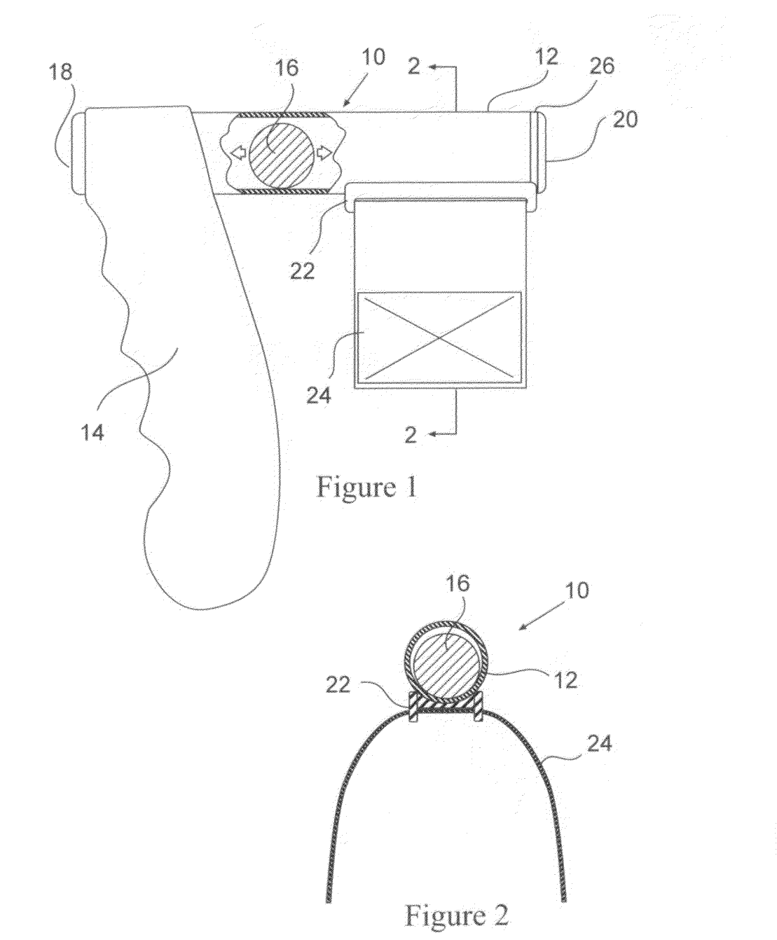

Referring to FIGS. 1 and 2, the trainer 10 of this invention includes a container 12, a handle 14 secured to the container 12 and a ball 16. The ball 16 is movable between a closed forward end 18 and a closed rearward end 20 of the container 12. The container 12 optionally can be provided with a bracket 22 through which a strap 24 extends. The handle 14 is shaped to permit the user to grasp it with the fingers. The strap is positioned to be wrapped about the user's hand thereby to assist in the user's securely holding the handle 14. The forward end 18 emits a relatively loud sound when the ball 16 strikes it. The rearward end 20 emits a relatively low sound or no sound when the ball 20 strikes it due to the energy absorbing material 26 attached to it. Thus, the user is provided with a desired contrast in sound when the ball 16 is moved between forward end 18 and rearward end 20.

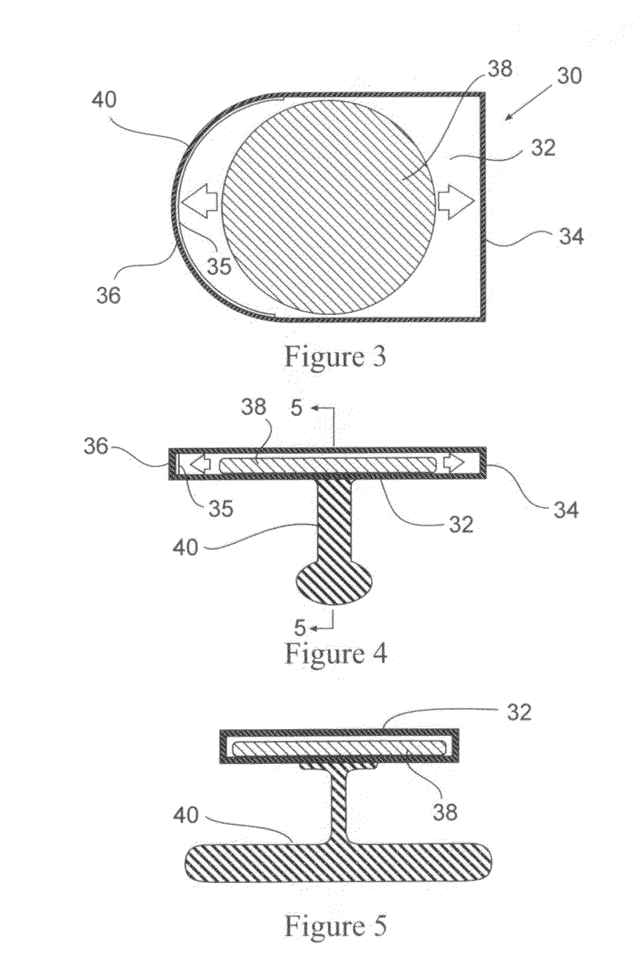

Referring to FIGS. 3, 4 and 5, the trainer 30 includes a container 32 having a closed rearward end 36 and a closed forward end 34. The rearward end 36 has an energy absorbing material 35 attached to its inner surface. The inner surface of forward end 34 is free of an energy absorbing material. Thus, a louder sound is emitted when the slideable disk 38 strikes the forward end 34 as compared to any sound emitted when the disc 38 strikes the rearward end 36. The handle 40 is attached to the container 32 in a manner so that a user can grasp it with his fingers. A strap also can be attached to the container 32 to be wrapped about the user's hand or wrist, if desired.

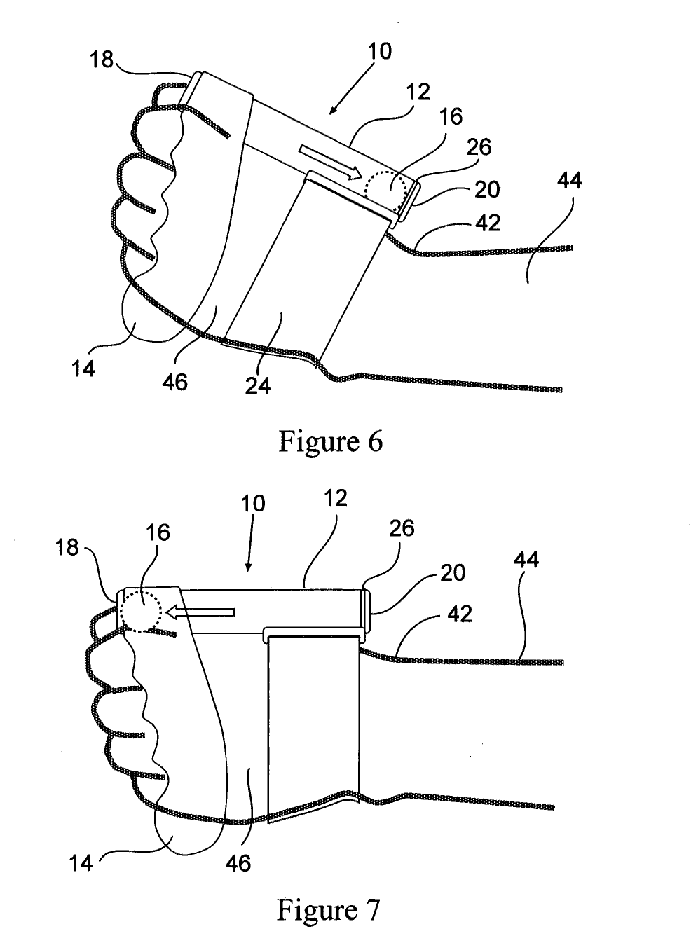

Referring to FIG. 6, the use of the trainer 10 of this invention is illustrated. In FIG. 6, the user's wrist 42 is shown in an on guard (cocked) position relative to the user's arm 44 and hand 46. When in this position, the ball is in contact with pad 26 at the rearward end 20 of container 12.

In FIG. 7, the user's wrist 42 is shown in an extended position relative to the user's arm 44 and hand 46. When the user's wrist 42 is moved from the cocked position of FIG. 6 to the extended position of FIG. 7, the ball 16 is propelled from rearward end 20 to forward end 18 of container 12. When the ball strikes forward end 18, an audible sound is produced which gives information to the user regarding the direction and strength of the blow delivered when the arm 44 is moved forward and the wrist 42 is uncocked thereby to simulate a blow delivered to a competitor. Repetition of the arm and wrist movement teaches the user information regarding an acceptable strong blow delivered.

The container 12 can be made of any strong hard material such as metal including steel or aluminum or a polymeric composition such as polycarbonate. The sound deadening material can be any energy absorbing composition such as soft polymeric foam.

1. A hand blow trainer which comprises:
(a) a container having a closed forward end and a close rearward end, said rearward end having an energy absorbing strip secured to its inner surface.
(b) a movable element positioned and movable within said container adapted to produce an audible signal when said element strikes said forward end to produce a muted audible signal or no audible signal when said element strikes said rearward end,
and (c) a handle attached to said container, said handle being adapted to permit said handle to be grasped by a hand of a user of said trainer.

2. The trainer of claim 1 which includes a strap secured to said container, said strap being adapted to be secured to a hand of said user.

3. The trainer of claim 1 wherein the movable element is a ball.

4. The trainer of claim 2 wherein the movable element is a ball.

5. The trainer of claim 1 wherein the movable element is a disc.

6. The trainer of claim 2 wherein the movable element is a disc.
